(19) United States
(12) Patent Application Publication
(10) Pub. No.: US 2026/0225630 A1
(43) Pub. Date: Aug. 6, 2026

(54) SYSTEMS AND METHODS FOR ASSESSING TRACK CONDITION

(71) Applicant: FNV IP B.V., Leidschendam (NL)

(72) Inventors: Karim EL LAHAM, Leidschendam (NL); Tulika BOSE, Leidschendam (NL); Neda SEPASIAN, Leidschendam (NL)

(73) Assignee: FNV IP B.V., Leidschendam (NL)

(21) Appl. No.: 19/152,130

(22) PCT Filed: Feb. 12, 2024
(86) PCT No.: PCT/EP2024/053415

§ 371 Date: Jul. 30, 2025

(30) Foreign Application Priority Data
Feb. 15, 2023 (NL) 2034149

(51) Int. Cl. B61L 23/04; B61L 25/02; B61L 27/53; G01S 17/34

(52) U.S. Cl. CPC B61L 23/042; B61L 25/025; B61L 27/53; G01S 17/34

(57) ABSTRACT

The disclosure relates to systems and methods for determining track condition. The method comprises the steps of: receiving a signal indicative of position H₁ of a surface of a rail at a location X under a first load condition; receiving a signal indicative of position H₂ of a surface of the rail at the location X under a second load condition, wherein the first load condition is different from the second load condition. The method further comprises determining ΔH, wherein ΔH=H₁−H₂ and wherein ΔH indicates deformation of the rail, and further determining a value indicative of local track condition based on ΔH. Unlocking insights from Geo-Data, the present invention further relates to improvements in sustainability and environmental developments: together we create a safe and liveable world.

### FIELD

The disclosure relates to a systems and methods for assessing a track condition. More specifically, the disclosure relates to system of assessing track condition by comparing the track position under differing load conditions to determine local track stiffness. Unlocking insights from Geo-Data, the present invention further relates to improvements in sustainability and environmental developments: together we create a safe and liveable world.

### BACKGROUND

Rail-based infrastructure (such as inter-city or urban railways, high-speed rail, monorails, metro or underground rail systems, light rail, heavy or industrial rail, magnetic levitation rail) is often a valuable physical asset that requires ongoing monitoring and maintenance across a network of track routes. One of the challenges faced by asset owners, managers and users is the need to monitor and maintain the condition of the track network, without (or with minimal) disruption to services. Predicting track condition across the network (and thus required maintenance works) can be challenging because degradation of the track is not uniform across the network. Rather, degradation in track condition generally occurs more rapidly at weak points. In some instance, weak points such as points and crossings can be predicted. However, rapid degradation of track condition may also occur at unidentified points in the network, which are difficult to predict. For example, degradation of the track may occur at points in the network where the track has ‘settled’ unevenly.

Railways are generally constructed of a pair of horizontal rails, resting upon a plurality of sleepers, arranged perpendicular to the direction in which the rails extend. The sleepers rest upon a layer of gravel ballast, which itself sits above a base layer of compacted material (e.g. crushed stone). The track ideally has a flat and smooth vertical profile, with minimal local variations in track height at the rail head (the top portion of the rail). Ideally, the track further has a constant spacing between the two rails, and minimal local horizontal deviation of one or both rails. Uneven settling of the ballast or base layer, uneven deterioration of the sleepers, and/or improper contact between the tracks, sleepers or ballast can undermine one or more of these track requirements.

Similar problems can also occur across other rail-based infrastructure networks, such as tram networks, metro or underground rail systems, high-speed rails, or the like. Moreover, potential problems are not limited to track networks comprising two parallel rails. Monorail networks may also suffer from track degradation that compromises transport services that rely on the network. Similarly, magnetic levitation tracks may also suffer from degradation of the track, leading to similar uncertainties in requirements of track maintenance.

Reducing disruptive maintenance requirements on low- or reduced-carbon transport networks has the potential to increase the total capacity of the network, thereby reducing carbon emissions associated with temporary requirements to use alternative higher-carbon transport options whilst the network undergoes maintenance. Moreover, improving the reliability of lower-carbon transport options is a key requirement for increased uptake of rail-based passenger and freight options.

There is therefore need for improved systems and methods for monitoring track condition.

### SUMMARY

The present disclosure provides improved systems and methods for monitoring track condition by comparing rail behaviour under first and second load conditions.

In a first aspect of the disclosure, there is provided a method for determining track condition, the method comprising: receiving a signal indicative of position H₁ of a surface of a rail at a location X under a first load condition; receiving a signal indicative of position H₂ of a surface of the rail at the location X under a second load condition; wherein the first load condition is different from the second load condition; and wherein the method further comprises: determining ΔH, wherein ΔH=H₁−H₂ and wherein ΔH indicates deformation of the rail; determining a value indicative of local rail condition based on ΔH. Since the track comprises at least one rail, track condition may be monitored by monitoring the stiffness of at least one constituent rail that forms part of the track. The value indicative of local rail condition may be indicative of or an approximation of local rail stiffness. The signal indicative of position H₁ and/or H₂ can comprise a calculated value of H₁ and/or H₂ at point X, e.g. based on measured values of H₁ and/or H₂ either side of point X. Alternatively, the signal indicative of position H₁ and/or H₂ can comprise a measured value at point X.

Positions H₁ and H₂ may be expressed as a (measured or calculated) vertical distance between a collector and the railhead. The position H may be measured directly (e.g. by a collector positioned directly above a railhead and configured to measure a vertical or perpendicular distance between the rail head and the collector). Alternatively, H may be determined geometrically from a non-vertical measured value. The position H may be defined relative to a baseline external to the measurement system, e.g. a point on the zero line of the measured rail. Position H may be an absolute position value.

The method can further comprise receiving a signal indicative of H₁ at a plurality of locations under the first load condition and receiving a signal indicative of H₂ at a plurality of locations under the second load condition. The signals may be discrete point values, e.g. collected at a sampling rate. The sampling rate may be expressed as a frequency (e.g. Hz) or may be expressed as a distance measurement along the rail (in the x-direction). The measurement of H₁ and H₂ may also be continuous, and/or expressed as a continuous waveform. Accordingly, the method may comprise determining ΔH as a function of location X, for the plurality of locations.

The method can further comprise determining the location X (for each measured value of H) using received GPS coordinates.

Determining location X can comprise: cross-referencing received GPS coordinates with one or more coordinates associated with a reference station, optionally a virtual reference station.

Additionally or alternatively, determining location X can comprise receiving data indicative of an acceleration of a sensor configured to measure position H, at location X, and determining the location of the sensor based on acceleration information in combination with a known reference point. For example, the received acceleration data may be combined with global positioning data to determine location X.

The method can further comprise: determining one or more threshold values for ΔH for identifying additional action such as location flagging, track maintenance and/or additional monitoring based on the threshold value being exceeded.

The one or more threshold values for ΔH can include one or more of: a single absolute value for ΔH; a cumulative value for ΔH as a function of X; a mean value for ΔH; a count of ΔH over a predetermined threshold value.

The method can further comprise shifting the signal indicative of H₁ relative to the signal indicative of H₂. The signal can be shifted by a predetermined value. Alternatively, the shift can be identified by performing a cross-correlation, e.g. to determine a best fit alignment of the signals. By shifting the signal for H1 relative to H2, misalignment of the signals due to e.g. GPS inaccuracies and/or errors in determination of the location X can be compensated for.

The steps described above are carried out with received data. However, methods of the present disclosure may also include steps associated with collection of the data indicative of rail position and determination of location X.

For example, the method may further comprise applying a load to the track; measuring H₁ under the first load condition, wherein measuring H₁ comprises measuring deformation of the rail at a distance L₁ from a load contact point for the load; and measuring H₂ under the second load condition, wherein measuring H₂ comprises measuring deformation of the rail at a distance L₂ from the load contact point. In practice, applying a load to the track may comprise driving a vehicle over a section of track. The load may be a single load, with measurements taken under different virtual load conditions, e.g. at different distances from the applied load point. The load may also comprise multiple loads providing first and second differing load conditions.

Measuring H₁ under the first load condition can comprise applying a first load to the track and measuring H₁ under the first load. Measuring H₂ under the second load condition comprises applying a second load to the track and measuring H₂ under the second load, wherein the first load and the second load are different. It will be appreciated that ‘measuring’ comprises direct measurement, and indirect measurement of the location H₁ and H₂. For example, H₁ and H₂ may be measured indirectly by measuring a related distance (e.g. a non-perpendicular distance) and calculating position H₁ and H₂ as a perpendicular distance between the rail and the collector trigonometrically therefrom.

At least one of measuring distance H₁ and measuring distance H₂ may comprise using a LIDAR scanner to measure a distance, optionally a vertical distance, between the scanner and a surface of the rail.

In a second aspect of the disclosure, there is provided a computer system comprising one or more processors configured to carry out the steps described above.

In a third aspect of the disclosure, there is provided a computer readable medium comprising instructions, that, when executed by one or more data processing apparatus, cause the one or more processing apparatus to perform operations comprising the steps above.

In a fourth aspect of the disclosure, there is provided a system for measuring one or more parameters indicative of a condition of a track comprising one or more rail, the apparatus comprising: a vehicle body providing a load; a first sensing apparatus configured to measure a distance H₁ to a surface of the rail at a location located a first distance L₁ from a load contact point for the load; a second sensing apparatus configured to measure a distance H₂ to a surface of the rail at a location located a second distance L₂ from a load contact point for the load, wherein L₁ is greater than L₂. The distance H₁ may be a perpendicular distance between the collector and the rail, such that L₁ equals the distance between the collector and the load contact point. Alternatively, the collector may measure a non-perpendicular distance between the collector and the rail, such that L₁ is not equal to the distance between the load contact point and the collector.

In a fifth aspect of the disclosure, there is provided a kit of parts comprising: a first sensing apparatus configured to be mounted to a load and measure a distance H₁ to a surface of the rail at a location located a first distance L₁ from a load contact point for the load; a second sensing apparatus configured to be mounted to the load and measure a distance H₂ to a surface of the rail at a location located a second distance L₂ from a load contact point for the load, wherein L₁ is greater than L₂. The distance H₁ may be a perpendicular distance between the collector and the rail, such that L₁ equals the distance between the collector and the load contact point. Alternatively, the collector may measure a non-perpendicular distance between the collector and the rail, such that L₁ is not equal to the distance between the load contact point and the collector.

### BRIEF DESCRIPTION OF THE DRAWINGS

The disclosure will be further described with reference to illustrative embodiments and in connection with the following drawings, in which:

FIG. 1 shows a schematic of a section of railway track comprising a pair of rails;

FIGS. 2A and 2B each show a plot of a vertical deformation of a section of rail under an applied load;

FIG. 3 shows a signal representative of a position H between a collector and a rail head as a function of track location X;

FIG. 4 shows a schematic view of a measurement unit comprising a LIDAR scanner for determining a position H, expressed as a distance between a collector and a rail head, as a function of location;

FIG. 5a shows a first system for measuring track condition under a first load condition and a second load condition;

FIG. 5b shows a second system for measuring track condition under a first load condition and a second load;

FIG. 5c shows a third system for measuring track condition under a first load condition and a second load;

FIG. 5d shows a fourth system for measuring track condition under a first load condition and a second load;

FIG. 6 shows a plot of equivalent load vs. distance from load contact point;

FIG. 7 shows a flow diagram of a method according to the disclosure;

FIG. 8 shows a comparison of first and second signals indicative of rail position;

FIG. 9 shows a flow diagram of a method according to the disclosure;

FIG. 10 shows a computer system for carrying out the various methods of the disclosure.

### DETAILED DESCRIPTION OF THE DRAWINGS

The following detailed description is merely exemplary in nature and is not intended to limit the application and its uses. Furthermore, there is no intention to be bound by any expressed or implied theory presented in the preceding technical field, background, brief summary or the following detailed description. As used herein, the term ‘module’ refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realised by any number of hardware, software, and/or firmware components configured to perform the specified functions. For example, an example embodiment of the present disclosure may employ various integrated circuit components, e.g. memory elements, digital signal processing elements, logic elements, look-up tables, or the like, which may carry out a variety of functions under the control of one or more microprocessors or other control devices. In addition, those skilled in the art will appreciate that embodiments of the present disclosure may be practised in conjunction with any number of systems, and that the systems described herein are merely exemplary embodiments of the present disclosure.

For the sake of brevity, conventional techniques compared to signal processing, data transmission, signalling, control and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connection may be present in an embodiment of the present disclosure.

Systems and methods described herein relate to monitoring and/or determination of parameters indicating track condition. In general terms, embodiments of the present disclosure provide techniques and equipment for determining and comparing local rail deformation under first and second load conditions, and then comparing the deformation of the rail under the first and second load conditions to determine a value indicative of local rail stiffness. Since low local rail stiffness can indicate weak points of a track or rail prone to rapid degradation, failure or safety incidents, embodiments of the present disclosure can provide technique for monitoring track condition to inform e.g. predictive maintenance requirements. Moreover, changes in local rail stiffness over time can indicate localised degradation a section of track, before incidents that may lead to network disruption.

The first and second load conditions can be chosen to represent an ‘unloaded’ measurement and a ‘loaded’ ‘measurement. According to European standards (set out in EN13848-1_2019), a loaded measurement in the field of railway monitoring and maintenance is generally understood to mean that the applied loading at the measuring point of the rail shall be equivalent to a minimum vertical wheel load of 25 kN. In practice, this means that track monitoring equipment located, during use, at a relatively large longitudinal distance from a wheel axle may constitute an ‘unloaded’ measurement, whereas the same monitoring equipment located (during use) close to the wheel axle may constitute a loaded measurement. In light of this, it will be appreciated that an ‘unloaded’ measurement is not generally understood to require that no load is applied to the track. Rather, the maximum virtual load applied to the track at the location of measurement is less than 25 kN. It is noted that the European standards on loaded measurements are in place to ensure that sufficient information related to deformation of the rail is measured (i.e., that the pressure on the rail is sufficient to attain a certain level of deformation at the location of measurement). Such information is required by many standards (including European standards) because tracks must perform and meet safety standards under normal use conditions, which include loading of the track by e.g. cargo or passenger vehicles. Accordingly, the European standards define the loaded measurements because unloaded measurements are deemed not to provide useful information on track quality.

Note that the definitions of ‘loaded’ and ‘unloaded’ above are those defined in the European regulatory standard document EN13848-1_2019. Different regulatory definitions of ‘loaded’ and ‘unloaded’ measurements may apply in other jurisdictions and it is not the intention of this disclosure to limit the embodiments described herein to use within a European regulatory regime. Rather, it will be appreciated, in particular in light of the following disclosure, that embodiments of the present disclosure make use of track measurements gathered under a first load condition and a second load condition, wherein the first and second load conditions are different. In the context of the present disclosure therefore, it is not essential that either of first or second measurements is ‘unloaded’. Rather the first load conditions should be different from the second load conditions (e.g. the first load should be greater than the second load) to allow a comparison between the two measurements.

In the detailed description that follows, embodiments of the disclosure will be described in the context of train tracks that form part of a railway network, and comprise two rails. However, it will be appreciated that the present disclosure is not limited to implementation in this context, and the advantages associated with the present invention may be employed on other rail networks, e.g. rail transport networks such as tram ways or monorails. Moreover, the present disclosure may be useful outside of the context of networks for human transport and may also be applied to indoor and outdoor rail or track networks configured to carry freight and/or equipment.

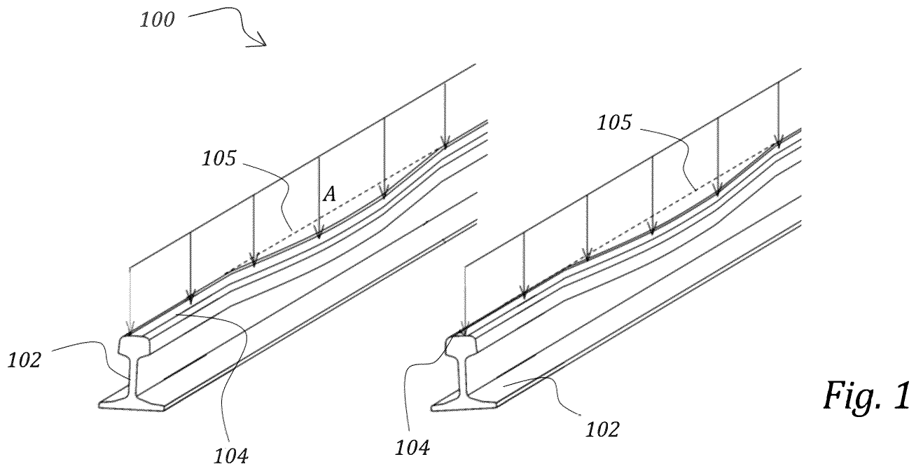

Turning now to FIG. 1, a section of track 100 is shown. The track comprises a pair of parallel rails 102, each rail comprising a rail head 104, which provides an upper surface along which the wheels of a vehicle run. The track 100 shown in FIG. 1 is a section of railway track and thus comprises two parallel rails 102. However, it will be appreciated that the present disclosure is applicable to systems having a single rail, or indeed three or more rails.

As shown in FIG. 1, each of the rails 102 of track 100 has suffered a deformation in which the rail 102 is vertically displaced (see arrow A). The dotted line 105 in FIG. 1 shows the location of the upper surface of an ideal, undeformed rail head, known as the ‘zero line’. Vertical deviations from the ideal form for the rail can result in degradation and eventually failure of the track, but also may cause damage and wear and tear to vehicles travelling on the section of track or serious safety incidents, such as derailments. Vertical deviation of the rails may also reduce comfort for passengers.

According to European safety standards (see e.g. EN13848-1_2019), rail defects may be classified as falling into the following three wavelength ranges:

$$D 1 : 3 m < λ \leq 25 m$$

$$D 2 : 25 m < λ \leq 70 m$$

$$D 3 : 70 m < λ \leq 200 m$$

An additional range, DO is defined in EN13848-1_2019, in which 1 m<λ≤5 m, which may be used to detect short wavelength defects that can generate high dynamic forces.

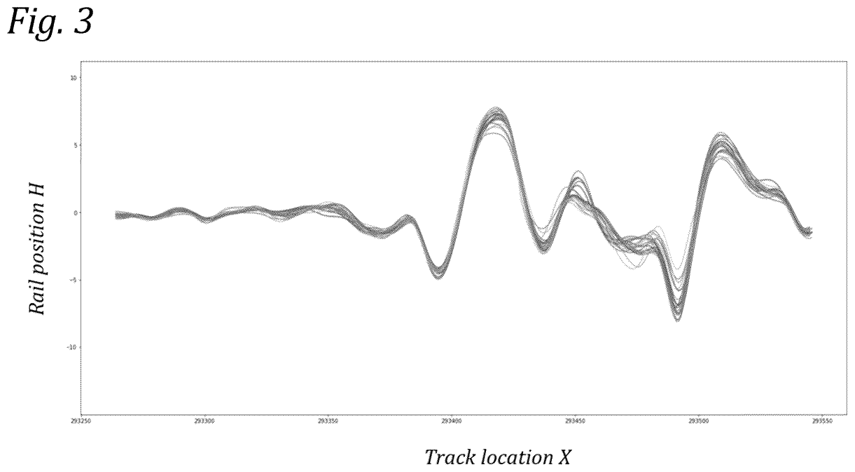

Defects of different wavelengths have different real-world impacts for vehicles travelling on the tracks. For example, whilst very short-wave defect (e.g. in the DO range) can create very high dynamic forces, defects in e.g. the D2 wavelength range may be more prone to cause derailments if left unmitigated. Defects in the D3 wavelength range are most impactful in connection with high-speed lines. For example, studies intended to identify defects in the D3 wavelength should be considered for line speeds over 200 or even 230 km/h. The wavelength A of a defect is the length of the deviation, e.g. in the example shown in FIG. 1, the wavelength A is the distance between the first deviation from the zero line 105 to the point at which the rail returns to close to the zero line. It will be appreciated that the zero line is not restricted to a horizontal line (e.g. perpendicular to a plum line). Rather, the zero line can be defined relative to large-scale geographical or structural features that alter the trajectory of the track from horizontal. For example, a track that climbs or descends an incline (e.g. as a result of a hill or bridge crossing) will have an inclined and/or curved zero line. In practice, and in the context of the present disclosure, the impact of large-scale track curvature and/or track gradient on the calculation of rail deviation relative to the zero line can be accounted for by filtering the received signal (e.g. such as the signal shown in FIG. 3) to retrieve wavelengths for the domain of interest (e.g. D2).

One of the challenges associated with railway monitoring and maintenance is advance or predictive identification of defects likely to occur in the safety-critical D2 wavelength range.

It will be appreciated that the vertical displacement of the rail head 104 shown in FIG. 1 may occur due to deviation from the zero line 106 of the rail 102 in the absence of a load (e.g. due to uneven settling of the track) or it may only occur (or worsen) as a load passes over the track, for example the rail may deform elastically as the wheel of a train carriage passes over the rail 102. Deformations that only occur (or worsen significantly) when a load is applied are indicative of low local rail stiffness. Low local rail stiffness can be predictive of future defects that compromise track safety or integrity, in particular those occurring in the D2 wavelength range.

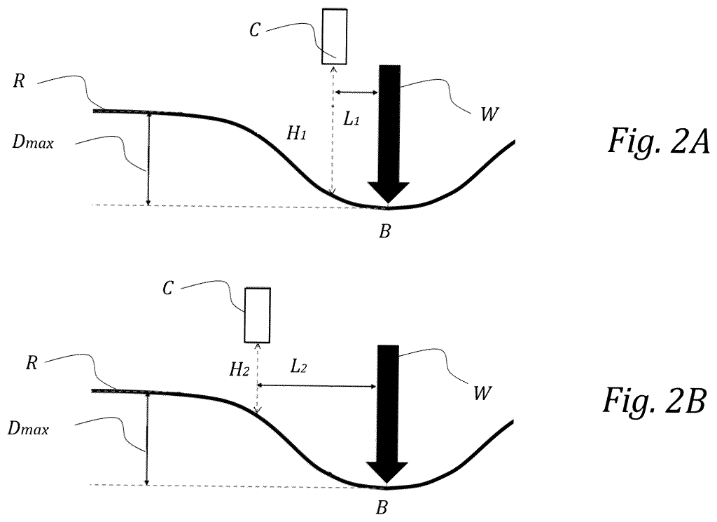

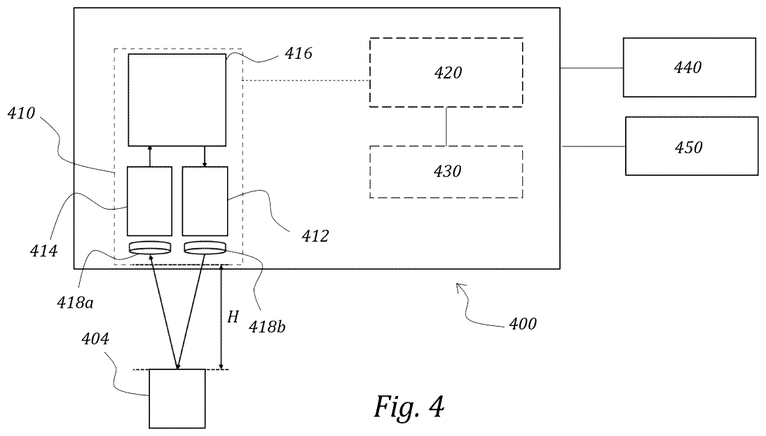

Turning now to FIGS. 2A and 2B, a schematic representation a system for measuring the deformation of a section of rail under a load is shown. FIGS. 2A and 2B illustrate deformation of a rail R under a load W and show the same rail under the same load. In each case, the system comprises a collector C, mounted with respect to the load W, and configured to measure a distance H between the collector C and the rail R. The collector C is mounted a distance L from the load W. The collector C may comprise a LiDAR scanner, one example of which will be described with reference to FIG. 4. As will be apparent from the following description, the collector C can be used to measure a vertical position of the rail under a given load condition.

However, as will be apparent from FIGS. 2A and 2B, measurement of distance H under two different load conditions can provide additional insights into e.g. rail stiffness, that may not be possible with studies carried out under a single or constant load condition.

As shown in FIG. 2A under the application of a load W to the rail, the vertical position of the rail changes as the rail deforms under the weight of the load W. The load W may be a wheel of a carriage (see, e.g. wheel 420 in FIG. 4a). The maximum deformation of the rail from the zero position is indicated as Dₘₐₓ.

The vertical position of the rail can be measured with collector C. The collector C can measure a distance H₁ between the rail (e.g. upper surface of the rail) and the collector C. The distance H₁ can be a vertical distance between the upper surface of the rail head (see rail head 104 in FIG. 1) and a collector mounted directly thereabove or it can comprise the vertical component of a diagonal distance measured between the collector and the rails. The measured distance H₁ can be used as a raw value (as will be explained below) or it may be used (together with known parameters) to determine a position of the rail relative to a predefined baseline, e.g. the zero line.

FIG. 2A shows the deformation of the rail and the distance H₁ measured by a collector C mounted at a first longitudinal distance L₁ from the load W.

FIG. 2B represents the deformation of the rail R (under the same load W as in FIG. 2A) as measured by a collector C mounted a second longitudinal distance L₂ from the load W, where L₁≠L₂. The collector C is configured to measure the distance H₂ between the collector C and an upper surface of the rail head.

As shown in FIGS. 2A and 2B, at the point B at which the load W is applied (e.g. the point at which a carriage wheel contacts the rail, the rail deforms a total distance Dₘₐₓ from its rest position. Due to the flexibility of the rail, as a distance L from the load point B increases, the displacement D of the rail decreases. Accordingly, a distance H₁ measured by a collector C positioned distance L₁ from the load (FIG. 2A) is greater than a distance H₂ measured by a collector C positioned distance L₂ from the load (FIG. 2B). This is because the rail relaxes as the load passes over the rail (e.g. as the distance from the load W increases).

A distance ΔH between H₁ and H₂ can be calculated wherein ΔH=H₁−H₂. In the event that a difference ΔH between H₁ and H₂ is small, the deformation of the rail under the load is relatively low, and the local rail stiffness can be assessed as being relatively high. However, if the difference ΔH between H₁ and H₂ is high, the deformation of the rail is relatively high, and the local rail stiffness can be assessed as being relatively low. Relatively high rail stiffness is correlated with sections of track less prone to rapid degradation. However, low local rail stiffness may be an indicator of track defects (e.g. broken fasteners, breakage in sleepers, small defects in the rail body, degraded insulated block joints, degraded welds, etc.). Accordingly, identifying a value of ΔH above a threshold or identifying an increasing value of ΔH over time can identify minor track defects that are predictive of more serious track defects in future.

In light of the above, it will be appreciated that it is possible to collect a first measurement for H₁ using a collector mounted at a distance L₁ from an axle that corresponds to a loaded measurement and a second measurement H₂ can be collected at a distance L₂ from the axle, such that the measurement corresponds to an unloaded measurement (as described above). For example, the distance L₁ may be less than 2 m, more preferably less than 1.5 m, more preferably approximately 1 m from a load point. For example, the distance L₂ may be greater than 2 m, more preferably greater than 3 m, and preferably approximately 3.5 m from the load point.

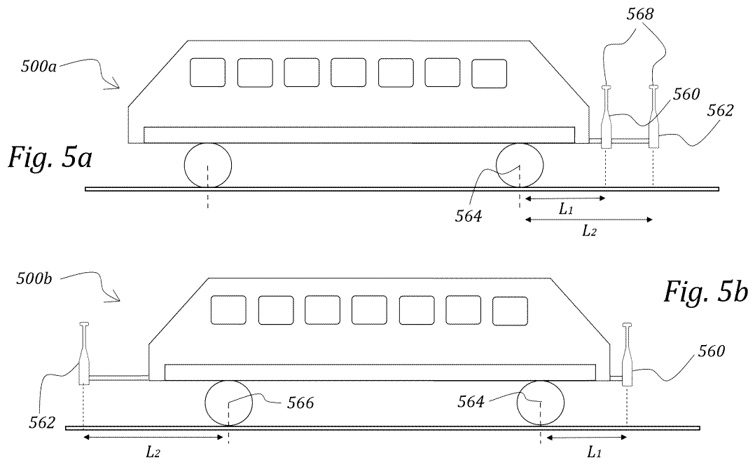

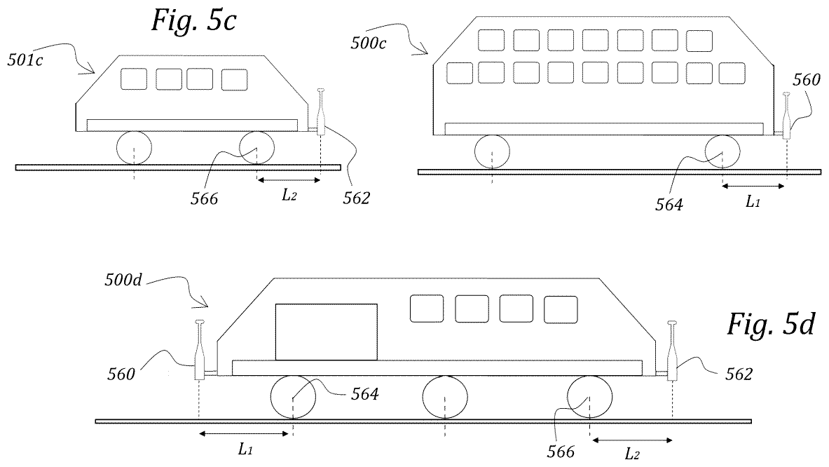

It should be noted that the difference in the distances L₁ and L₂ create different load conditions on the section of rail measured by collector C. The difference in the measured value ΔH under these differing load conditions can be used to provide insights into rail stiffness, as will be explained in more detail below. It will also be noted that although in the example above the differing load conditions under which the measurement of H is collected is created by the difference between L₁ and L₂. However, other approaches to collecting measurements under different load conditions will become apparent from the description of FIGS. 5a to 5D.

Turning now to FIG. 3, a collector C can be configured to measure one or more discrete values of H. The collector C can be configured to measure distance H at a predefined frequency, e.g. a predetermined sampling rate. The sampling rate may be between 0.1 Hz and 1000 Hz, more preferably between 1 Hz and 500 Hz, more preferably between 50 Hz and 300 Hz, more preferably between 100 Hz and 300 Hz. In one embodiment, the sampling rate may be approximately 250 Hz. The sampling rate may also be chosen based on a predetermined measurement spacing, e.g. to ensure a measurement of the rail is taken every 20 cm, every 25 cm, every 30 cm, etc. along the rail. Accordingly, the frequency of the sampling rate of the scanner can be determined based on a measured, calculated or known velocity of the measurement unit.

Alternatively, the collectors C can be configured to continuously monitor the distance H to provide a continuous signal representative of the distance H as a function of location X for each rail. FIG. 3 shows an example of a measured signal representative of distance H as a function of location X for a left rail and a right rail. The distance H is shown on the y-axis, whist the location X is shown on the x-axis. The multiple lines on the plot indicate the signal measured on a plurality of dates for the same section of track. The plot shown in FIG. 3 shows the measured distance H as a function of location X for a single collector.

Turning now to FIG. 4, an exemplary collector will be described, in the context of a measurement system 400. The measurement system 400 may be used in the system shown in FIG. 2. That is, the measurement system 400 of FIG. 4 may be used as a collector C as shown in FIG. 2.

In at least one exemplary embodiment, the measurement system includes a collector comprising a LiDAR (Light Detection and Ranging) scanner. In general terms, LiDAR systems allow for the determination of ranges by targeting an object or surface with projected laser radiation and measuring the time it takes for reflected light to be returned to a receiver. LiDAR systems therefore generally comprise an emitter or projector of laser radiation, i.e. a laser source, and a receiver or imaging device configured to detect reflected laser radiation, i.e. a detector. Although several other measurement systems for determining H may be used, the present disclosure is exemplified with reference to a LIDAR scanning system, as will be described below.

As shown in FIG. 4, the measurement system 400 comprises a scanner 410, e.g. a LIDAR scanner, which is mounted on a support (not shown) that allows it to direct radiation towards the railhead. In FIG. 4, the rail head is shown schematically as a block 404.

The LiDAR scanner 410 comprises a laser source 412, a detector 414, and a signal processor 416. The laser source 412 is configured to emit laser light into the environment, in the present case towards rail head 404. As shown in FIG. 4, the emitted light is reflected from the rail head 404 towards the detector 414. The signal processor 416 is in operative communication with the detector 414 and is configured to determine the distance from the scanner to the surface from which the light is reflected. Lenses 418a, 418b may be provided deliver and collect light from and to the source and detector respectively. Other optical components (not shown) may also be provided to direct, focus, collect or otherwise steer the laser beam as needed within the collector 410. In the configuration shown in FIG. 4, the scanner 410 is mounted directly above the railhead (e.g. with no lateral offset). However, it will be appreciated that the present disclosure is not limited to this configuration and a vertical distance H to the railhead can be determined geometrically even where the scanner 410 is not mounted directly above the railhead, as illustrated schematically in FIG. 4.

Various LiDAR systems may be used. For example, the laser source 412 can be configured to emit pulsed laser radiation or it may be configured to emit amplitude modulated radiation (e.g. a continuous light wave of varied intensity).

For embodiment employing pulsed laser LiDAR imaging techniques, the distance X can be determined by measuring a time of flight (t_{oF}) of emitted radiation pulses from the collector, to the surface, here rail head 404, and from the rail head 404 to the collector. The distance H can be calculated using the following formula:

$$H = c / 2$$

where c is the speed of light and t_{oF} is the measured time of flight

For embodiments using a continuous wave amplitude modulated approach (AMCW), the phase-shift induced in an intensity-modulated periodic signal in its trip from source to surface to detector to determine the distance H. Typically, the optical power of the emitted radiation is modulated with a constant frequency f_{M}. Measurement of the distance H is calculated from the phase shift ΔΦ that occurs when the emitted signal and the reflected signal:

$$Δ Φ = {k}_{M} l = ( 2 π {f}_{M} / c ) 2 H ⇒ H = c 2 ΔΦ2π {f}_{M}$$

where k_{M} is the wave number associated with the modulation frequency, c is the speed of light, l is the total distance travelled, f_{M} is the modulation frequency of the amplitude of the signal

Although pulsed approach and AMCW LiDAR systems are briefly described above, it will be appreciated that embodiments of the present disclosure may also use a continuous wave frequency modulated approach (FMCW). Moreover, although the collector C of FIGS. 2A and 2B may take the form of a LiDAR scanner 410 as shown in FIG. 4, it will be appreciated that other systems and apparatus for measuring the distance H can be employed. For example, the position H may be determined by determining a position of a sensor (e.g. an accelerometer) based on measured acceleration of the sensor, relative to a predetermined or calculated starting point. Moreover, the position H may be determined by a mobile laser scanning (MLS) system, a terrestrial laser scanning (TLS) system or flash LiDAR. Additionally, or alternatively, embodiments of the invention may comprise a camera configured to capture an image of the rail and surroundings. The captured image may be analysed to determine a position H, expressed as a distance between the camera (or reference point) and the railhead. It will also be appreciated that the present disclosure comprises embodiments comprising multiple sensors for measuring the position H. By providing multiple measurement means for determining H, redundancy may be provided that can allow measurement errors to be identified, and/or to allow correction of measured values.

Moreover, although the embodiments described herein comprise a measurement or calculation of the position H as a (vertical) distance (from a predetermined point to the rail head), the present disclosure may make use of chord measurements to determine the height profile of a rail with a view to determining deformation of the rail.

The collector 410, whether it be a LIDAR scanner or other system for determining H, may form one part of a wider measurement system that includes one or more of an inertial measurement unit (IMU) 420 configured to determine one or more of the acceleration of the measurement unit (e.g. heading, pitch, roll). The measurement system 400 may further comprise a global positioning system (GPS) 430 configured to determine a location of the measurement system. The GPS system can comprise a global navigation satellite system (GNSS antenna), and may be configured to log location data from reference station (e.g. a virtual reference station).

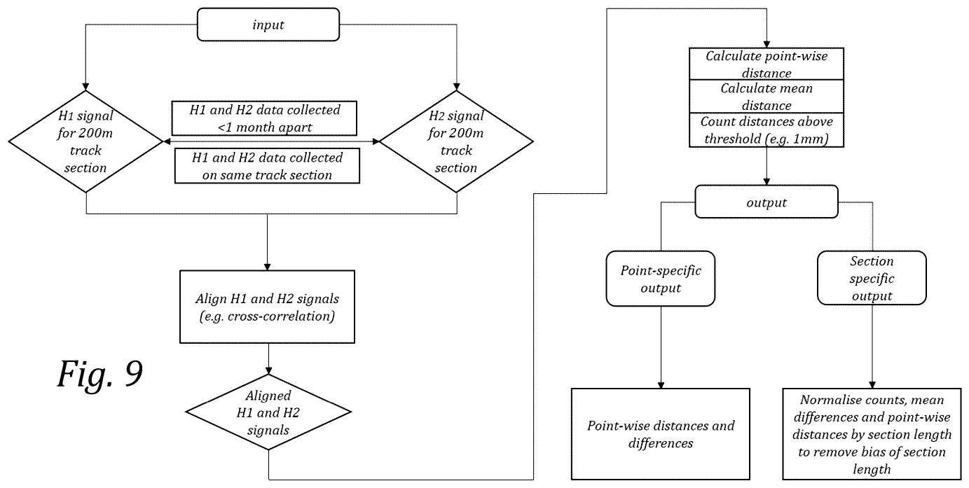

The measurement system 400 may also comprise a memory 440 to store captured data from one or more components of the measurement system. The system 400 may also comprise a communication module 450 configured to communicate captured data to an external system (e.g. system 900 shown in FIG. 9). The communication module 450 may be configured to provide a wired connection and/or a wireless connection to an external system. It will be appreciated that the system 400 can be configured to store and/or communicate raw signal data. Alternatively or additionally, the system 400 may be configured to process the raw data before communication via the communication module.

One example of a measurement system suitable for use in the context of the present disclosure is described in WO2018/208153 A1, the entire disclosure of which is hereby incorporated by reference. As described in this document, a measurement system for mapping a track geometry can comprise two light projector devices (e.g. laser fan beam projectors) configured to generate and project collimated light beams towards the rails of a section of track. The measurement system also comprises two image acquisition devices (e.g. cameras) for receiving light reflected by the rails, that act as the detector 414 indicated in FIG. 4.

Turning now to FIGS. 5a to 5d, systems for measuring rail geometry under (at least) two different load conditions will now be described. As explained with reference to FIG. 2, measuring the location of a railhead relative to a collector under two different load conditions can indicate local stiffness of a rail section. In the schematic shown in FIG. 2, the first and second load conditions for first and second measurements H₁ and H₂ are created by applying load W at point X and measuring the position of the railhead at distance L₁ from the load and at distance L₂ from the load. FIG. 5a shows an exemplary vehicle 500a configured to capture first and second position measurements H₁ and H₂ under first and second load conditions. As shown, the exemplary vehicle 500a comprises a first collector 560 and a second collector 562. The first collector 560 is mounted a distance L₁ from a first wheel axle 564. The second collector 562 is mounted a distance L₂ from the first wheel axle 564 of the vehicle 500a. The first wheel axle 564 defines the load point for the rail with respect to which the distance L (between the collector and the load) is defined. The collectors by be in operative communication with an antenna 568, e.g. to allow for communication with a global positioning system. The collectors 560, 562 shown in FIG. 5a each comprise an antenna. However, it will be appreciated that a single antenna may be provided in operative communication with both collectors. It will also be appreciated that although FIG. 5a illustrates each collector located in its own housing, and configured to direct light substantially vertically towards the rail head, the collectors 560, 562 of FIG. 5a may form part of a combined measurement system in which each collector is located substantially the same distance from the axle 564, but is configured to collect position information H at a different location relative to the axle (the distance L is determined between the axle and the location X at which the value H is measured). For example, each collector may be configured to direct laser radiation towards the railhead at a different angle α (relative to the zero position of the rail) such that the beam is incident on the rail at two different distances L₁ and L₂ from the load point 564.

FIG. 5b shows an alternative embodiment in which a vehicle 500b comprises a first collector 560 mounted a first distance L₁ from a front axle 564 and a second collector 562 mounted a second distance L₂ from a rear axle 566. In this embodiment, the measuring systems 508, 510 are offset from different respective axles. However, the received signal (see e.g. FIG. 3) from collector 562 can be shifted relative to the received signal from collector 560 to allow comparison of H₁ and H₂ as measured at location X on the rail. Note that this shift can be calculated based on received GPS data, or it may be calculated based on the known wheelbase of the vehicle 500b. Thus, the vehicle 500b shown in FIG. 5b allows for measurement data captured under two different load conditions at location X.

FIG. 5c shows yet another system configured to capture longitudinal rail data under two different load conditions. As shown in FIG. 5c, two vehicles are provided: a first vehicle 500c having a first axle 564 (providing a load point) and a second vehicle 501c having a second axle 566 (providing a load point). In this case, the distance L₁ between the collector 560 and the load point is the same as the distance L₂ between the second collector 562 and the load point. However, the load conditions under which the first and second collectors record a signal is different due to the differing loads applied by the vehicles 500c and 501c. In practice, vehicle 501c may be a lightweight vehicle that exerts a significantly lower force on the rails than vehicle 500c. The lightweight vehicle 501c may allow for ‘unloaded’ measurements to be taken, regardless of the location of the collector 562 relative to the axle 566.

FIG. 5d shows another embodiment in which a value for longitudinal position of the rail head relative to a scanner is measured under two different load conditions. As shown in FIG. 5d, a vehicle 500d with an uneven weight distribution is provided. The load at the rear axle 564 (on the left-hand side of the figure) is significantly greater than the load at the front axle 566 (at the right-hand side of the figure). Therefore, although L₁=L₂, the load conditions at the location X where the first and second measurements are taken is different.

With reference to FIGS. 5a to 5d, a plurality of systems that allow for rail measurement under first and second (different) load conditions are provided. It will be appreciated that the first and second load conditions provided by the systems may both be considered ‘loaded’ system (according to the relevant regulatory standard, e.g. EN13848-1_2019). For example, both the first and second load conditions may present an effective load (or equivalent load) at distances L₁ and L₂ from the load of greater than 25 kN (the threshold for loaded/unloaded measurements according to EN13848-1_2019), thereby allowing for the measurement of the track under two different ‘loaded’ conditions, a less loaded and a more loaded condition.

Alternatively, the systems described with reference to FIGS. 5a to 5d may allow for one of the first and second load conditions to be considered ‘loaded’ (according to a relevant regulatory standard, such as EN13848-1_2019 in Europe), whilst the other of the first and second load conditions is considered to provide an ‘unloaded’ measurement, e.g. with an effective load at the measurement location of less than 25 kN. One manner in which an ‘unloaded’ measurement can be taken is by spacing the collector in a longitudinal direction from the load point (e.g. the axle).

In the embodiments illustrated in FIGS. 5a-5d, a vehicle comprising a measurement system configured for use in the context of the present disclosure is shown. However, it will be appreciated that the measurement systems shown in FIGS. 5a-5d and described with reference to all of the preceding embodiments may be provided as a kit of parts configured to be retrofit to existing vehicles. For example, a kit of parts can comprise a first sensing apparatus configured to be mounted to a load and measure a distance H₁ to a surface of the rail at a location located a first distance L₁ from a load contact point for the load; a second sensing apparatus configured to be mounted to the load and measure a distance H₂ to a surface of the rail at a location located a second distance L₂ from a load contact point for the load, wherein L₁ is greater than L₂. The distance H₁ may be a perpendicular distance between the collector and the rail, such that L₁ equals the distance between the collector and the load contact point. Alternatively, the collector may measure a non-perpendicular distance between the collector and the rail, such that L₁ is not equal to the distance between the load contact point and the collector.

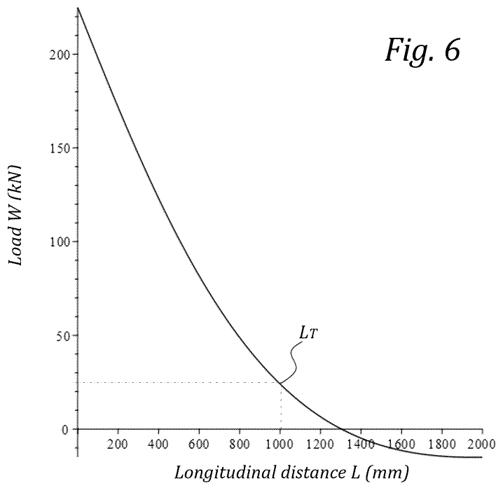

FIG. 6 shows a graph of modelled equivalent load W (kN) vs. the distance L from the load at which the position measurement H is taken. The exemplary model shown in FIG. 6 assumes a wheel load to be 225 kN. At a longitudinal distance of 0 mm from the axle, the load on the rail is 225 kN. As the distance L from the axle increases (along the x-axis) the equivalent or virtual load at the point a distance L from the load decreases. For the example shown in FIG. 6, the equivalent load decreases below the 25 kN ‘loaded’ measurement threshold at approximately L_{T}=1 m from the axle. Therefore, selecting a distance L greater than L_{T} allows for a ‘loaded’ measurement, whereas a distance L less than L_{T} allows for an unloaded measurement. In this manner, embodiments of the present disclosure allow for the capture of ‘loaded’ and ‘unloaded’ data. In at least one exemplary embodiment, distance L₁ (as shown in e.g. FIG. 5a) is less than approximately 1.5 m, more preferably approximately 1.1 m, and more preferably 1 m or less. Distance D2 (as shown in e.g. FIG. 5a) may be greater than 2 m, greater than or equal to approximately 3 m and preferably approximately 3.1 m. The difference between L₁ and L₂ may be at 1 m or more, more preferably 1.5 m or more, and more preferably 2 m or more. In at least one embodiment, the difference between L₁ and L₂ may be approximately 2 m. It will be appreciated that the ranges provided above for L₁ and L₂, and/or the ranges for L₁-L₂, may be particularly advantageous in the context of the measuring system being mounted with respect to a conventional passenger train or a measurement train.

Although in the exemplary implementations described herein, threshold values for loaded and unloaded measurements are described with reference to a European standard (EN13848-1_2019) it will be appreciated that this threshold value is exemplary in nature and that other threshold values may be used. Moreover, since it is not essential for either of the measurement signals to be collected under ‘unloaded’ conditions, it will be appreciated that it is not necessary to collect loaded and unloaded measurements to benefit from the advantages provided by the present disclosure associated with comparing measurement signals under differing first and second load conditions.

It will be noted that the modelled virtual load illustrated in FIG. 6 shows a ‘negative’ virtual load at distances greater than approximately 1.3 m from the load point. This is as a result of the behaviour of the rail (as a flexible solid body) in the context of its placement within a composite track environment (e.g. the rail is coupled to sleepers, resting on ballast, laid over a substrate). As the rail deforms at a first point under the load at the load point, at a point remote from the load point, the rail may lift slightly. As shown, the negative virtual load at a distance L from an applied load W can be modelled, and may therefore be compensated for, if desired, in the measured signal representative of H. However, correction for a virtual negative load is not required to determine valuable insights into rail stiffness based on ΔH because the distances L₁ and L₂ can be fixed such that any displacement resulting from a negative virtual load at L₁ and/or L₂ is constant or substantially constant.

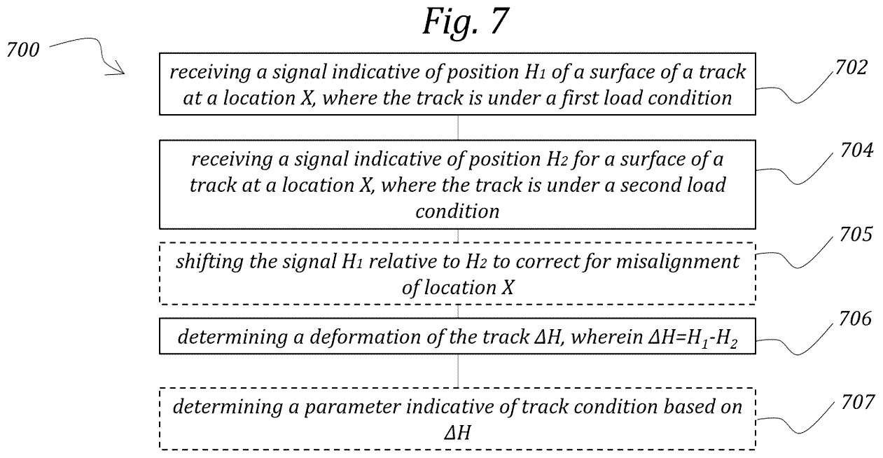

Systems and methods for measuring rail data under first and second load conditions have been described above with reference to FIGS. 1 to 6. Turning now to FIGS. 7 to 9, an exemplary method for determining a track condition based on gathered track data will now be described. It will be appreciated that the methods and processes described below do not require the step of gathering the raw data. Rather, the systems and methods described below may receive gathered data in order to determine a value indicative of rail stiffness.

In general terms, and with reference to FIG. 7, a method 700 for determining track condition comprises the steps of: receiving 702 a signal indicative of position H₁ of a surface of a rail at a location X, when the rail is under a first load condition; receiving 704 a signal indicative of position H₂ of a rail at the location X when the rail is under a second load condition, wherein the first load condition is different to the second load condition. The method further comprises determining 706 a deformation of the rail ΔH, wherein ΔH=H₁−H₂.

The method may optionally comprise determining 707 a parameter indicative of track condition, e.g. a value or score for track condition based on ΔH, at location X. The parameter may be indicative of local rail stiffness. The method may further comprise calculating rail stiffness based on ΔH, for example using Hooke's law, whereby a section of rail is modelled or approximated as a leaf spring.

In at least one example, the value indicative of track condition is simply ΔH. For example, a threshold value for determining poor track condition may be a threshold value for ΔH.

For example, the method can further comprise assigning an action flag to one or more sections of track based on ΔH (or a value or score for track condition based on ΔH). For example, an action flag may comprise an indication that a section of track should be subjected to increased monitoring. Or an action flag may comprise an indication that a section of track should be subject to maintenance, immediately or at a predefined time interval.

The method may also comprise shifting 705 signal H₁ relative to H₂ to correct for misalignment of the position value X. In at least one embodiment, shifting the signal representative of H₁ relative to the signal representative of H₂ comprises: cross-correlating the respective signals H to determine at which x-axis value the signals are most correlated (and thus most aligned). Optionally, this step may comprise sampling data points for each signal into a spline function that fits the respective signal and resampling the data points at a predefined interval (e.g. 25 cm), to make sure that both data sets are sampled at consistent intervals. The x-axis shift required to align the H₁ and H₂ signals can be added (or subtracted) to the signal to achieve alignment of the signals (such that the location of X for H₁ and X for H₂ is the same).

In at least some embodiments, the step of shifting the signal H₁ relative to H₂ to align the signals with respect to the position value X involves shifting signal H₁ along the x-axis relative to H₂ by a predefined amount. The predefined x-axis shift may be determined based on a known, fixed distance between the collectors (e.g. a distance between collector 560 and collector 502 in FIG. 5a). In other embodiments, the predefined x-axis shift can be based on a constant calculated during a pre-collection calibration step (not shown in FIG. 7). The calibration step may comprise collecting a sample of data comprising signals representative of H₁ and H₂, with collectors a fixed distance apart. The calibration step may comprise: cross-correlating the respective sample signals to determine at which x-axis value the signals are most correlated (and thus most aligned) to determine a predefined x-axis shift value. The pre-defined x-axis shift may then be applied during step 705 of method 700.

Although not shown in FIG. 7, the method 700 may optionally further comprise the step of determining a position H₁ under a first load condition and determining a position H₂ under a second load condition (in particular, in at least one example, with reference to the approach set out in connection with FIGS. 1 to 6).

In at least one exemplary embodiment, the GNSS antenna may operate at a sampling frequency of approximately 5 Hz. The inertial measurement unit IMU may have a sampling frequency of 300 Hz. The LiDAR scanner may have a sampling frequency of approximately 250 Hz. For a vehicle travelling at 100 km/h along a section of track, this can result in a sampling interval of 5.56 m for the GPS system, 0.09 m for the IMU and 0.11 m for the IMU. At 160 km/h, this results in a GPS sampling interval of 8.89 m, an IMU sampling interval of 0.15 m, and a LiDAR sampling interval of 0.18 m.

The sampling frequencies above are presented above as an example of sampling frequencies that have been found by the inventors to provide valuable insights into track condition at common operating speeds for commercial rail vehicles. However, it will be appreciated that the sampling frequency for one or more of the GNSS, IMU and LiDAR may be varied to provide the desired study resolution, and/or to accommodate different speeds for the carrier vehicle on which the measurement system is mounted.

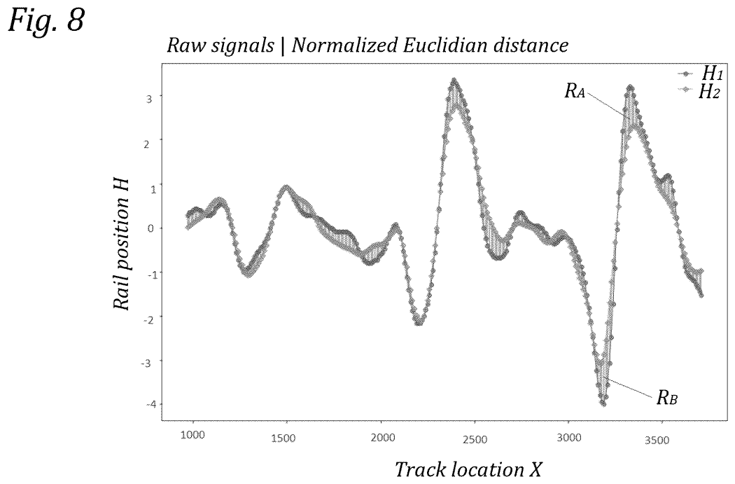

Turning now to FIG. 8, a plot of position H as a function of location X for distances is measured under the first and second load conditions. The signals are aligned such that X for H₁ is equal to X for H₂. The alignment may be due to a cross-correlation processing step (as described above) or it may be calculated by shifting the H₁ and H₂ signals a predetermined distance from each other (e.g. a known distance between the two collectors).

In the plot shown in FIG. 8, the y-axis shows the measured position H between the collector and the surface of the rail head (see FIG. 1). The x-axis shows the rail position, indicated here as a numerical value from a known starting point, in m. The plot includes two signal traces: a first indicating H₁ (as measured under first load conditions) and the second indicating H₂ (as measured under the second load condition). As shown in FIG. 8, a normalised Euclidian distance d can be measured between the two traces, representing ΔH, or the relative deformation of the rail between the first load condition and the second load condition. The Euclidian distance d can be calculated according to the following formula:

$$d = √ [ ( x 2 - x 1 ) \hat{} 2 + ( y 2 - y 1 ) \hat{} 2 ]$$

In practice, if the signals are perfectly aligned (with respect to the x-axis), and so the measurement H₁ at point X matches exactly with the measurement H₂ taken at point X, then in the equation above, x₂−x₁=0 and the Euclidean distance d is equal to the absolute value of the difference ΔH.

However, it will be appreciated that it is not essential that the point-wise values for H (as measured at location X) be aligned (in the x-direction) in order for the value ΔH to be calculated. Rather, the value ΔH may be calculated by interpolating a value for H₂ at a location X for which there is a measured value for H₁, but no directly aligned value for H₂ (e.g. the determined location X for the measurement H₁ is slightly different to the determination location for the measurement of H₂). As an example, for a data set in which the location XA at which a measurement for H₁ is taken falls between two adjacent locations X_{P} and X_{Q} at which data has been collected for H₂, a value for H₂ at location XA can be interpolated based on the gradient of the line representing H₂ between X_{P} and X_{Q}.

In the example shown in FIG. 8, two regions R_{A} and R_{B} are highlighted in which the value for ΔH is greater than 1 mm. In the example represented by the data shown in FIG. 8, this value for ΔH indicates an area of low rail stiffness. It should be noted that although 1 mm is included here as a threshold value highlighting regions R_{A} and R_{B} for closer scrutiny in this example, an alternative threshold value may be chosen. The threshold may be chosen based on e.g. the first and second load conditions, the type of track, the history of track maintenance required, track characteristics (e.g. switch points, crossings, etc.).

Referring now to FIG. 9, a more detailed, exemplary method according to the disclosure will now be described.

As shown in FIG. 9, the method comprising receiving an input. The input comprises a signal representing H₁ (e.g. a measured or calculated distance between a collector and the rail measured under first load conditions) and a signal representing H₂ (e.g. a measured or calculated distance between a collector and the rail measured under second load conditions). As shown in FIG. 9, the signals (H₁ and H₂) were collected less than one month apart. That is, a time interval between collection of the H₁ signal and the H₂ is less than one month. The signals H₁ and H₂ were also collected across the same section of track, in this case a 200 m section of track. Following input, the exemplary method includes aligning the H₁ and H₂ signals. As described above, this may be done with a cross-correlation step. The next step of the flowchart includes: calculating a point-wise distance (between aligned points), calculating a mean difference between the points over a section of predetermined length and counting the number of differences above a threshold, e.g. 1 mm. Although a threshold of 1 mm is used in this example, it will be appreciated that a different threshold may be chosen, for example the threshold may be 0.5 mm or greater, 0.7 mm or greater, or 1 mm or greater. Larger threshold values may also be used, for example a threshold of 1.2 mm of greater, 1.5 mm or greater of 2.0 mm or greater may be used.

One or more of the above may comprise the output of the method. As shown in FIG. 9, the output of the method may be used to provide a point-specific output (e.g. point-wise distances and differences). Alternatively, the output may be used to provide a section specific output. For example, the count (of differences over a threshold), the mean differences and point-wise differences by section length (e.g. to remove bias of section length). Note that normalisation of the count for section length avoids, for example, a long section length being identified as problematic based on above-threshold count alone.

The exemplary methods described above comprise, as an input, a signal indicative of the distance H between a collector and a rail head. In the examples described, the collectors H are mounted a fixed distance from the zero position of the rail head such that H₁ and H₂ for an undeformed section of rail are equal. However, it will be understood that this is not required and the collectors may be offset, and offset corrected in a pre-processing step (e.g. before, during or after the steps of the method 700 described with reference FIG. 7).

Moreover, an additional or alternative pre-processing step may comprise filtering the received signal to identify defects in a desired wavelength. For example, the received signal may be filtered (e.g. with a high-or-low pass, or a band-pass filter step) to identify the defects in a wavelength range of interest.

Moreover, although the distance H is defined relative to the collectors in the embodiments, it will be appreciated that distance H may be defined relative to an alternative reference point. For example, the position H may be measured relative to an axle. In some embodiments, the position H between an axle and the rail may be measured using a camera.

The position H may also be defined as an absolute measurement, e.g. within a global coordinate system.

Further, the location X at which the position H is measured may be defined as an absolute location (e.g. within a global coordinate system) or the location X may be identified as a relative location defined relative to a fixed point e.g. a start location for a defined section of track.

In one illustrative example, a measurement system according to the present disclosure, such as measurement system 400, may be configured to record a GNSS position of the measurement unit at a predefined interval (e.g. at 8.89 m intervals along the track) at a predefined operating speed (e.g. an operating speed of 160 km/h). To improve the accuracy of the GNSS data, the data collected by the measurement unit (e.g. acceleration data from the IMU) can be post-processed in conjunction with the data from an active GNSS reference network and supplemented with Virtual Reference Stations (VRS), which may be calculated at predetermined (e.g. 10 km) intervals along the track. The IMU can be configured to measure the acceleration and orientation of the measurement system 400. In an optional post-processing step, IMU and GNSS data may be integrated, which enables post-processed calculation of intermediate points between primary GNSS positions at predefined (e.g. 0.148 m) intervals. As a result, a high accuracy trajectory solution can be obtained for georeferencing the track data, to determine location X. To further improve the accuracy of determination of the rail location X, an integrated solution involving point clouds collected by the LiDAR scanner and the laser vision systems can be used. In this optional step, track distances between adjacent track lines can be calculated from point clouds of the LiDAR scanner and measured accurately. The point clouds may be used to adjust the position of track data. Moreover, each survey may be repeated one or more times, for each studied section of track, to increase measurement certainty and decrease the effect of stochastic errors, i.e. GNSS related errors. Therefore, a high degree of the absolute accuracy of the rail position can be determined without the need for ground control (manual measurements).

One example of a system suitable for determining location X and comprising a GNSS in combination with an IMU is described in WO2018/208153A1, which is incorporated by reference.

The methods described above with reference to FIGS. 7 to 9 may be implemented by a processing system, for example in the form of a computing device. Accordingly, the methods described herein may form all or part of a computer implemented method.

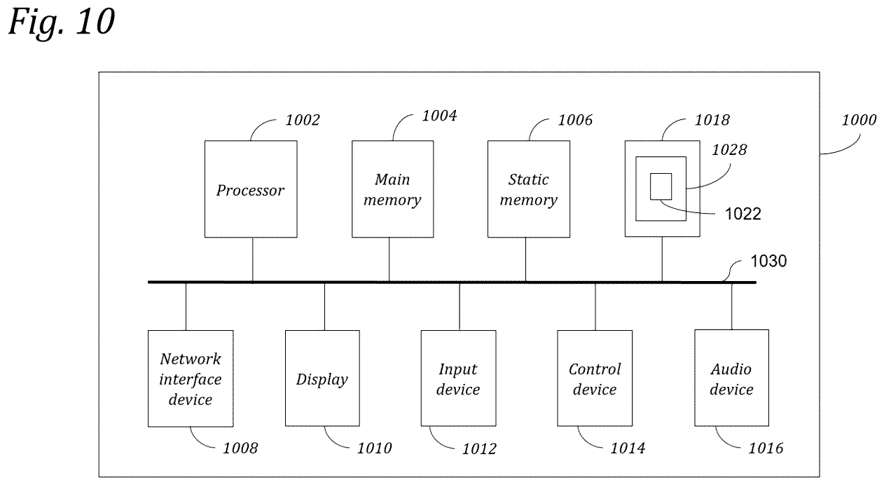

With reference to FIG. 10, a computing device 1000 suitable for carrying out the methods described above will now be described. FIG. 10 shows a block diagram of one implementation of a processing system 1000 in the form of a computing device within which a set of instructions for causing the computing device to perform any one or more of the methodologies discussed herein, may be executed. In alternative implementations, the computing device may be connected (e.g., networked) to other machines in a Local Area Network (LAN), an intranet, an extranet, or the Internet. The computing device may operate in the capacity of a server or a client machine in a client-server network environment, or as a peer machine in a peer-to-peer (or distributed) network environment. The computing device may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single computing device is illustrated, the term “computing device” shall also be taken to include any collection of machines (e.g., computers) that individually or jointly execute a set (or multiple sets) of instructions to perform any one or more of the methodologies discussed herein.

The example processing system 1000 includes a processor 1002, a main memory 1004 (e.g., read-only memory (ROM), flash memory, dynamic random access memory (DRAM) such as synchronous DRAM (SDRAM) or Rambus DRAM (RDRAM), etc.), a static memory 1006 (e.g., flash memory, static random access memory (SRAM), etc.), and a secondary memory (e.g., a data storage device 1018), which communicate with each other via a bus 1030.

Processor 1002 represents one or more general-purpose processors such as a microprocessor, central processing unit, or the like. More particularly, the processor 1002 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 1002 may also be one or more special-purpose processors such as an application specific integrated circuit (ASIC), a field programmable gate array (FPGA), a digital signal processor (DSP), network processor, or the like. Processor 1002 is configured to execute the processing logic (instructions 1022) for performing the operations and steps discussed herein.

The processing system 1000 may further include a network interface device 1008. The processing system 1000 also may include a video display unit 1010 (e.g., a liquid crystal display (LCD) or a cathode ray tube (CRT)), an alphanumeric input device 1012 (e.g., a keyboard or touchscreen), a cursor control device 1014 (e.g., a mouse or touchscreen), and an audio device 1016 (e.g., a speaker).

It will be apparent that some features of the processing system 1000 shown in FIG. 10 may be absent. For example, the processing system 1000 may have no need for display device 1010 (or any associated adapters). This may be the case, for example, for particular server-side computer apparatuses which are used only for their processing capabilities and do not need to display information to users. Similarly, user input device 1012 may not be required. In its simplest form, processing system 1000 comprises processor 1002 and main memory 1004.

The data storage device 1018 may include one or more machine-readable storage media (or more specifically one or more non-transitory computer-readable storage media) 1028 on which is stored one or more sets of instructions 1022 embodying any one or more of the methodologies or functions described herein. The instructions 1022 may also reside, completely or at least partially, within the main memory 1004 and/or within the processor 1002 during execution thereof by the processing system 1000, the main memory 1004 and the processor 1002 also constituting computer-readable storage media 1028.

The various methods described above may be implemented by a computer program. The computer program may include computer code arranged to instruct a computer to perform the functions of one or more of the various methods described above. The computer program and/or the code for performing such methods may be provided to an apparatus, such as a computer, on one or more computer readable media or, more generally, a computer program product. The computer readable media may be transitory or non-transitory. The one or more computer readable media could be, for example, an electronic, magnetic, optical, electromagnetic, infrared, or semiconductor system, or a propagation medium for data transmission, for example for downloading the code over the Internet. Alternatively, the one or more computer readable media could take the form of one or more physical computer readable media such as semiconductor or solid state memory, magnetic tape, a removable computer diskette, a random access memory (RAM), a read-only memory (ROM), a rigid magnetic disc, and an optical disk, such as a CD-ROM, CD-R/W or DVD.

The computer program is executable by the processor 1002 to perform functions of the systems and methods described herein. In particular, the computer program is executable by the processor 1002 to receive data collected during a data collection exercise in which a rail position H is measured under first and second load conditions (as described above).

In an implementation, the modules, components, and other features described herein can be implemented as discrete components or integrated in the functionality of hardware components such as ASICS, FPGAs, DSPs, or similar devices.

A “hardware component” is a tangible (e.g., non-transitory) physical component (e.g., a set of one or more processors) capable of performing certain operations and may be configured or arranged in a certain physical manner. A hardware component may include dedicated circuitry or logic that is permanently configured to perform certain operations. A hardware component may be or include a special-purpose processor, such as a field programmable gate array (FPGA) or an ASIC. A hardware component may also include programmable logic or circuitry that is temporarily configured by software to perform certain operations.

Accordingly, the phrase “hardware component” should be understood to encompass a tangible entity that may be physically constructed, permanently configured (e.g., hardwired), or temporarily configured (e.g., programmed) to operate in a certain manner or to perform certain operations described herein.

In addition, the modules and components can be implemented as firmware or functional circuitry within hardware devices. Further, the modules and components can be implemented in any combination of hardware devices and software components, or only in software (e.g., code stored or otherwise embodied in a machine-readable medium or in a transmission medium).

Unless specifically stated otherwise, as apparent from the following discussion, it is appreciated that throughout the description, discussions utilizing terms such as “receiving”, “determining”, “comparing”, “enabling”, “maintaining,” “identifying,”, “receiving”, “providing” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

It is to be understood that the above description is intended to be illustrative, and not restrictive. Many other implementations will be apparent to those of skill in the art upon reading and understanding the above description. Although the present disclosure has been described with reference to specific example implementations, it will be recognized that the disclosure is not limited to the implementations described but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

1. A method for determining a condition of a track comprising at least one rail, the method comprising:
receiving a first signal indicative of position H₁ of a surface of a rail at a location X under a first load condition;
receiving a second signal indicative of position H₂ of the surface of the rail at the location X under a second load condition, wherein the first load condition is different from the second load condition;
determining ΔH, wherein ΔH=H₁−H₂ and wherein the ΔH indicates deformation of the rail; and
determining a value indicative of local rail condition based on the ΔH.

2. The method of claim 1, wherein the value indicative of the local rail condition is indicative of local rail stiffness.

3. The method of claim 1, wherein the position H₁ and the position H₂ each represent a vertical position of the rail, such as a distance between a collector and a railhead.

4. The method of claim 1, further comprising:
receiving a third signal indicative of the position H₁ at a plurality of locations under the first load condition;
receiving a fourth signal indicative of the position H₂ at the plurality of locations under the second load condition; and
determining the ΔH as a function of the location X, for the plurality of locations.

5. The method of claim 1, further comprising:
determining the location X using received GPS coordinates.

6. The method of claim 1, wherein determining the location X comprises:
cross-referencing received GPS coordinates with one or more coordinates associated with a reference station, optionally a virtual reference station.

7. The method of claim 1, wherein determining the location X comprises:
receiving data indicative of an acceleration of a sensor configured to measure the position H₁ or the position H₂, at the location X; and
combining the data indicative of the acceleration with global positioning data to determine the location X.

8. The method of claim 1, further comprising:
determining a threshold value for the ΔH for identifying additional action such as location flagging, track maintenance and/or additional monitoring.

9. The method of claim 8, wherein the threshold value for ΔH is:
a single absolute value for the ΔH;
a cumulative value for the ΔH as a function of X;
a mean value for the ΔH; and
a count of the ΔH over a predetermined threshold value.

10. The method of claim 4, wherein the method further comprises shifting the first signal indicative of the position H₁ relative to the second signal indicative of the position H₂.

11. The method of claim 1, further comprising:
applying a load to the track;
measuring the position H₁ under the first load condition, wherein measuring the position H₁ comprises measuring deformation of the rail at a distance L₁ from a load contact point for the load; and
measuring the position H₂ under the second load condition, wherein measuring the position H₂ comprises measuring deformation of the rail at a distance L₂ from the load contact point,
wherein L₁ and L₂ are different.

12. The method of claim 1, wherein:
measuring the position H₁ under the first load condition comprises applying a first load to the track and measuring the position H₁ under the first load;
measuring the position H₂ under the second load condition comprises applying a second load to the track and measuring the position H₂ under the second load, wherein the first load and the second load are different.

13. The method of claim 1, wherein at least one of measuring the position H₁ and measuring the position H₂ comprises using a LIDAR scanner to measure a vertical distance between the LIDAR scanner and the surface of the rail.

14.-15. (canceled)

16. A system for measuring one or more parameters indicative of a condition of a track comprising one or more rails, the system comprising:
a vehicle body providing a load;
a first sensing apparatus configured to measure a position H₁ of a surface of the one or more rails at a location located a first distance L₁ from a load contact point for the load; and
a second sensing apparatus configured to measure a position H₂ of a surface of the one or more rails at a location located a second distance L₂ from the load contact point for the load, wherein L₁ is greater than L₂.

17. (canceled)

18. A system comprising:
A processor; and
a memory storing instructions, which when executed by the processor, causes the system to:
receive a first signal indicative of position H₁ of a surface of a rail at a location X under a first load condition;
receive a second signal indicative of position H₂ of the surface of the rail at the location X under a second load condition, wherein the first load condition is different from the second load condition;
determine ΔH, wherein ΔH=H₁−H₂ and wherein the ΔH indicates deformation of the rail; and
determine a value indicative of local rail condition based on the ΔH.

19. The system of claim 18, wherein the value indicative of the local rail condition is indicative of local rail stiffness.

20. The system of claim 18, wherein the position H₁ and the position H₂ each represent a vertical position of the rail, such as a distance between a collector and a railhead.

21. The system of claim 18, further comprising instructions which when executed by the processor, causes the system to determine a threshold value for the ΔH for identifying additional action such as location flagging, track maintenance and/or additional monitoring.

22. The system of claim 21, wherein the threshold value for ΔH is:
a single absolute value for the ΔH;
a cumulative value for the ΔH as a function of X;
a mean value for the ΔH; and
a count of the ΔH over a predetermined threshold value.
